(19) United States
(12) Patent Application Publication
(10) Pub. No.: US 2014/0149203 A1
(43) Pub. Date: May 29, 2014

(54) TARGETED ADVERTISING SYSTEM AND METHODS

(71) Applicant: NPV HUNGARY ZARTKORUEN MUKODO RESZVENYTARSAS, Budapest (HU)

(72) Inventors: Ágota NARANCSIK, Budapest (HU); Miklós VARGA, Budakeszi (HU)

(73) Assignee: NPV Hungary Zartkoruen Mukodo Reszvenytarsasag, Budapest (HU)

(21) Appl. No.: 13/686,583

(22) Filed: Nov. 27, 2012

(51) Int. Cl. G06Q 30/02

(52) U.S. Cl. CPC G06Q 30/0269; G06Q 30/0239
USPC 705/14.39; 705/14.66

(57) ABSTRACT

Systems and methods are provided for serving targeted advertisements over a communications network and motivating users to view the advertisements by compensating the users after they view an advertisement and verify that they are human and have viewed the advertisement. The targeting is based on target information provided by an advertiser being compared with user information provided by a user who is registered and logged into the system.

### FIELD OF THE INVENTION

The invention relates generally to systems and methods for serving advertisements for display over a communications network and, more particularly, to systems and methods for displaying, based on consumer entered information, targeted advertisements, while ensuring that the displayed advertisement will be watched and the privacy of the consumer entered information will be maintained.

### BACKGROUND OF THE INVENTION

Advertising using traditional media, such as TV, radio, billboards, newspapers and magazines is increasingly substituted by online advertising through the Internet. Most experts expect this trend to continue with online advertising spending forecast to exceed print media spending in 2012 in the US and growing at a faster pace than TV advertising spending for several years to come. As a result, the share of online advertising is expected to reach over 30% in the US by 2016 from below 10% just a few years ago.

Factors that play a key role in the proliferation of online advertising include the increased use of the Internet by consumers and the ability of online advertising to be targeted more precisely than other, traditional forms of advertising. Many of today's online advertising systems employ consumer targeting techniques, where users are identified and categorized based on their personal attributes and/or browsing habits, which are stored in centralized databases. The collected personal data is analyzed and used to match users' profiles with those of the advertisements' target audience in an effort to display advertisements that should be relevant to users and thereby more effective.

As online advertising becomes more prevalent and the number of advertisements displayed online increases, competition for the attention of users (also referred to as eyeballs) becomes more intense. This in turn leads to online advertisements becoming more intrusive and interruptive. For example, prior to watching a video on the Internet, often times a pre-roll video advertisement must be viewed or when attempting to view a webpage an interstitial must first be navigated, and so on. However, when using the Internet users are typically not interested in watching advertisements and therefore in response to the various aggressive advertising techniques they increasingly try to avoid advertisements through unconscious reactions (e.g., banner blindness) or through deliberate acts, such as ignoring the ads, using ad blockers, leaving a web page, etc.

The above practices and trends are troubling issues for today's online advertising practices. Users often are not aware that personal information is being collected (or the extent of the information and what—potentially false, misleading, delicate or compromising—information is collected). This raises privacy concerns. Additionally, because users are avoiding advertisements, only a small portion of them are successful in delivering their messages. Thus many online advertisement programs are not as effective as they can be.

Some forms of online advertising, most notably search engine optimization (SEO) addresses some of the above concerns, however, SEO is not appropriate for many advertisers and advertisements and also has its own limitations. For example, SEO does not lend itself to intensive ad campaigns, to brand/image advertising, etc.

In view of the foregoing, it would be advantageous to provide an improved system and method for selecting and displaying advertisements over the internet. It would further be advantageous to provide such systems and methods which ensure that the advertisement is being viewed. It would still be further advantageous to safeguard the privacy of a user's information when such information is used to target advertisements to that user.

### BRIEF SUMMARY OF THE INVENTION

Many advantages of the invention will be determined and are attained by the invention, which in a broadest sense provides systems and methods for presenting advertisements (“ads”) for display over a communications network, which ensure that the advertisements are viewed by the user.

Systems and methods are provided for serving targeted advertisements over a communications network and motivating users to view the advertisements by compensating the users after they view an advertisement and verify that they are human and have viewed the advertisement. The targeting is based on target information provided by an advertiser being compared with user information provided by a user who is registered and logged into the system.

Embodiments of the invention provide a system for selecting and displaying advertisements over a communications network. The system includes a user database configured to store user entered information, an advertisement database configured to store advertisement(s), a target database configured to store target information related to the advertisement(s), an advertisement selection application configured to receive a request for advertising from a user computer and select at least one advertisement from the advertisement database for display on the user device and a user interface configured to verify that the selected advertisement has been viewed by the user and that the user is a human. The request for the advertisement is generated by the user device upon a user logging on to the system and the selection of the advertisement is based at least in part on the user entered information and the target information.

Embodiments of the invention also provide a method for selecting and displaying advertisements over a communications network. The method includes receiving from an advertiser and storing at a server an advertisement and target information related to the advertisement. The method also includes receiving and storing at the server, user information that was entered into a user device by a user. The server receives a request for an advertisement, compares the target information with the user information, determines that a match exists between the target and user information and selects the advertisement for display on the user device. The server also attempts to verify that the advertisement is viewed by a human being using the user device. If the server verifies that the advertisement is viewed by a human being using the user device the server compensates the human being for viewing the advertisement.

### BRIEF DESCRIPTION OF THE DRAWINGS

For a better understanding of the invention, reference is made to the following description, taken in conjunction with the accompanying drawings, in which like reference characters refer to like parts throughout, and in which:

FIG. 1 is a block diagram of a system for selecting and serving targeted advertisements for display over a communications network (e.g., Internet) in accordance with embodiments of the invention;

FIG. 2 is a flowchart illustrating a user's interaction with a system in accordance with embodiments of the invention;

FIG. 3 is a flowchart illustrating an advertiser's interaction with a system in accordance with embodiments of the invention; and,

FIG. 4 is a flow chart illustrating a method for selecting and serving targeted advertisements and ensuring that the advertisements are viewed, in accordance with embodiments of the invention.

The invention will next be described in connection with certain illustrated embodiments and practices. However, it will be clear to those skilled in the art that various modifications, additions, and subtractions can be made without departing from the spirit or scope of the claims.

### DETAILED DESCRIPTION OF THE INVENTION

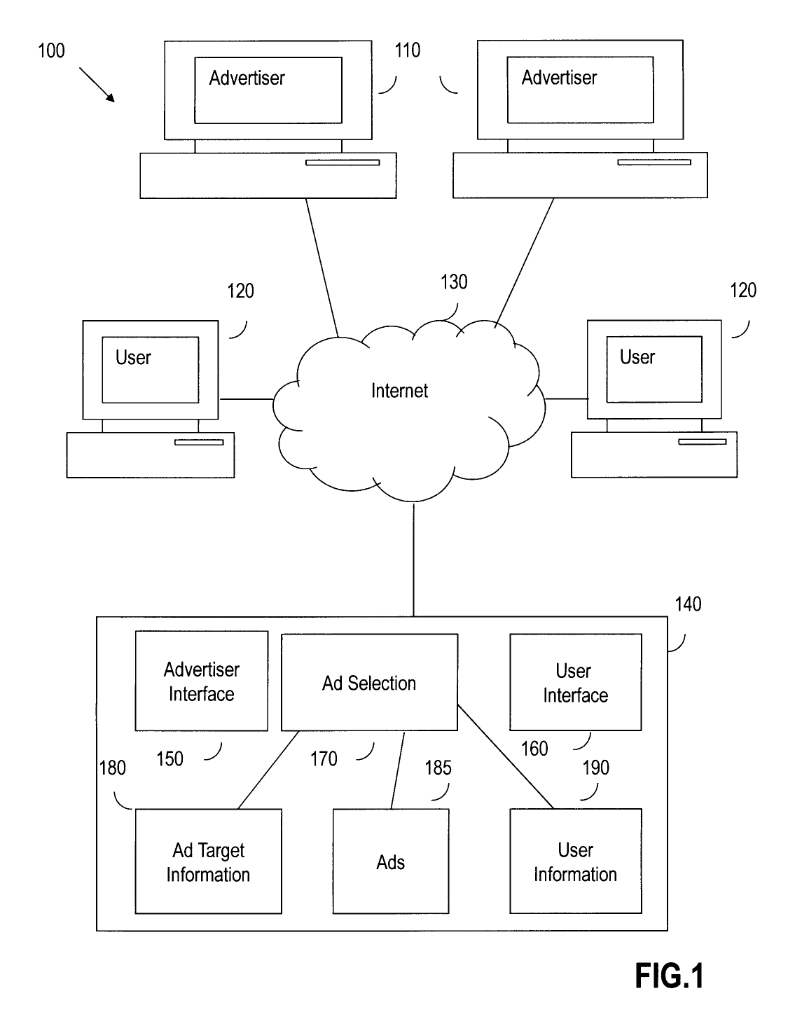

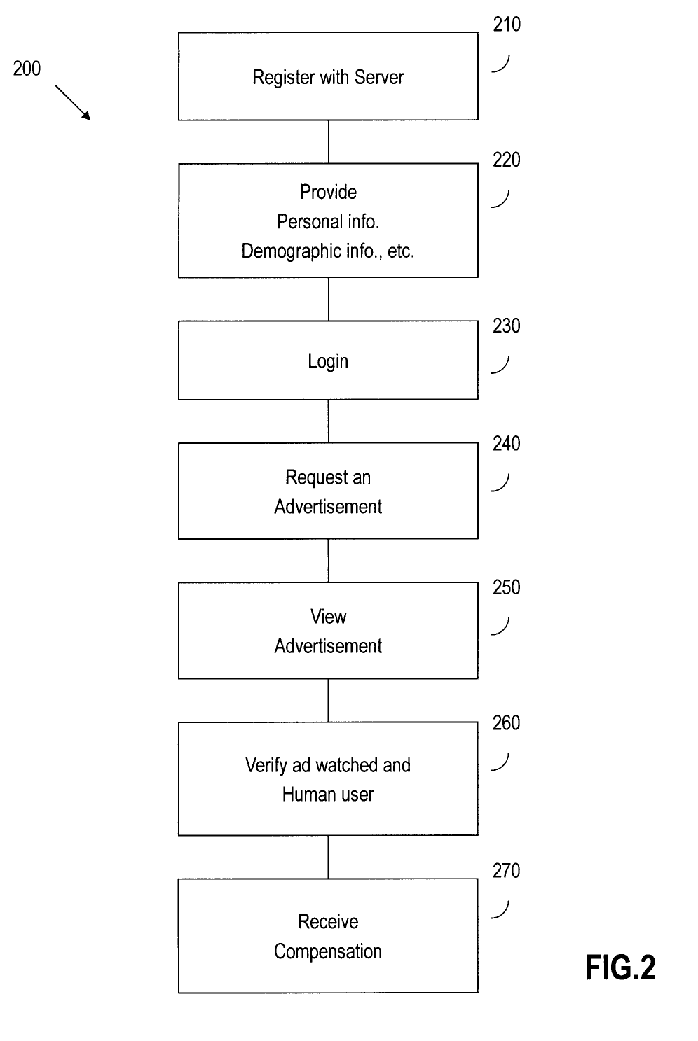

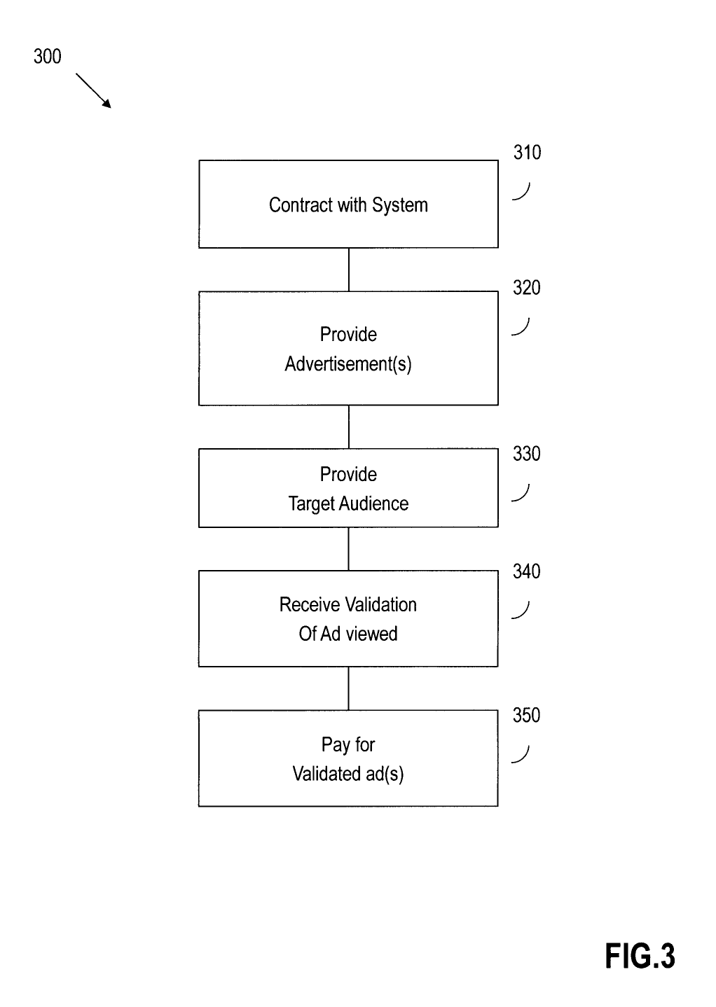

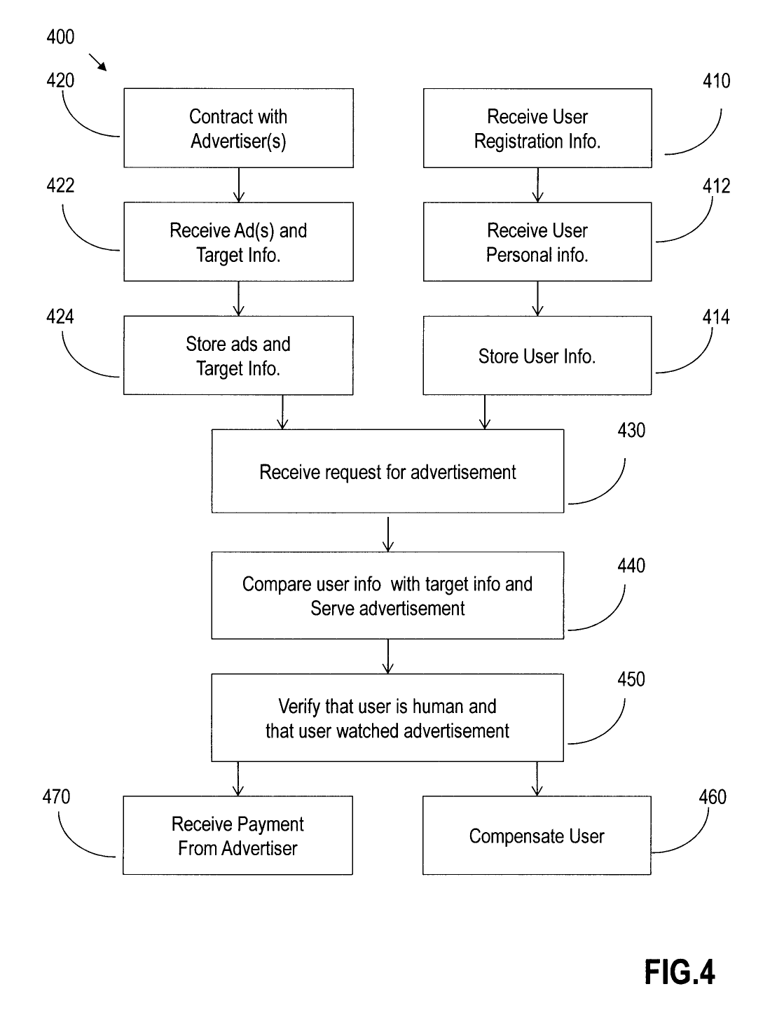

Referring to the drawings in detail wherein like reference numerals identify like elements throughout the various figures, there is illustrated in FIGS. 1-4 systems and methods for providing targeted advertisements over a communication network and motivating users to attentively view the advertisements. The principles and operations of the invention may be better understood with reference to the drawings and the accompanying description.

Referring to FIG. 1, in an exemplary embodiment of the invention, the system 100 includes advertisers 110 and users 120 who connect to the server 140 via the Internet 130 or some other network. Those skilled in the art will recognize that there are various conventional ways that an advertiser 110 or user 120 can connect to the system and that any of these methods may be employed without departing from a scope of the invention. Among such ways, although not exhaustive, are through a kiosk, direct connection, dial-up connection, a secure or unsecured connection, virtual private network (VPN), cable or satellite connection, a local area network (“LAN”), any other suitable wired, wireless, or optical connection, or a combination thereof. The server 140 includes a user interface 160, an advertiser interface 150, various databases 180, 185 and 190 and an ad selection module 170. The databases 180, 185 and 190 store the ads, the target information related to the ads and the user information. Ad selection module 170 compares the information from user database 190 and target information database 180 and based on the comparison selects one or more advertisements from database 185 to serve to user 120. Conventional techniques are widely known and employed for the purpose of selecting targeted advertisement(s) based on relevance, bid price, etc. and thus the process will not be further described herein. Those skilled in the art will recognize that interfaces 150, 160 could be a common interface that requires the party accessing the interface to select advertiser/user and verify the selected format. The interfaces 150, 160 and ad selection module 170 could be realized in hardware, software, firmware or any combination thereof. Those skilled in the art will recognize that while separate databases are illustrated, the information could be stored in a single database and still fall within a scope of the invention. Those skilled in the art will also recognize that while a single server 140 is illustrated that multiple servers may be employed.

User device 120 and advertiser device 110 may include any suitable computing equipment for accessing content (e.g., web pages) over Internet 130 or some other communications network 130 (e.g. television network, cable network, etc.) and displaying advertisements to end user(s) at user device 120. For example, as shown in FIG. 1, user device 120 may be a desktop computer. In other examples, user device 120 may be a laptop computer, tablet computer, telephone (e.g., mobile phone), personal digital assistant (“PDA”), BlackBerry device, television, set top cable or satellite box, or any other suitable computing device. Since different devices may be employed by the user and/or advertiser, reference to any one type of device will be understood to include any or all types of suitable computing equipment. For ease of description, the remaining disclosure will only refer to user computer 120 and advertiser computer 110. However, those skilled in the art will recognize that these references are not so limited and may be construed to be any suitable computing equipment. User computer 120 may have a web browser (e.g., Internet Explorer, Netscape Navigator, Mozilla Firefox) operating thereon for facilitating communications over Internet 130. Typically, system 100 will include multiple user computers 120 and advertiser computers 110 although only two user and advertiser computers 120, 110 are shown in FIG. 1 to avoid overcomplicating the drawing.

Referring to FIGS. 1, 3 and 4, advertiser 110 connects to server 140 through advertiser interface 150. This interface may provide advertiser 110 with various options such as upload an advertisement 320, upload or enter target information for an advertisement 330, delete an advertisement, review the analytics for one or more advertisements, add or modify the target information for one or more advertisements, pay the fee related to one or more advertisements 350, etc. Those skilled in the art will recognize that target information could be uploaded/entered prior to, simultaneous with or subsequent to uploading an advertisement and still fall within a scope of the invention. Those skilled in the art will also recognize that target information could be applied to a single advertisement or to multiple advertisements. When an advertisement is uploaded to server 140 it is stored in advertisement database 185. When advertisement target information is uploaded/entered it is stored in a target information database 180. Part of or separate from the target information could be the maximum number of times the advertisement should be served and/or a date range for serving the advertisement, a bid price for the advertisement, etc. When advertiser 110 selects the payment option 350, the system provides advertiser 110 a list of advertisements that were served and a confirmation of the number of validations 340 received for each. The advertiser pays for each advertisement that was served and validated.

Referring to FIGS. 1, 2 and 4, in an exemplary embodiment of the invention, a user 120 registers 210 (e.g., on the System's web page or user interface 160) with system 100, and sets up their personal accounts. Registration 210 may include entry of information such as name, unique user identification, password, contact details (e.g., e-mail, address etc.) and possibly some other basic information as may be required for the operation of the System. The System only accepts registrations from live natural persons and each person may only register once. Thus no duplicate registrations are allowed. While not preferred, it is contemplated that a system could be configured to allow multiple registrations, groups of individuals or even non-human registrations and still fall within a scope of the invention. The terms and conditions of the System may set further requirements or provisions for registration, such as minimum required age, etc., in line with business policies and local laws and regulations.

Registered users, in response to prompts, provide personal information about themselves, which may include, but is not necessarily limited to some or all the following: demographic information (e.g. age, gender, ethnicity, address, residence, etc.); education background, family status (e.g. married, living together, kids, pets, etc.); work status (e.g. employer, employer address, title, salary range, etc.); hobbies; interests; lifestyle (e.g. gay, heterosexual, transgender, own a car, lease a car, brand, model, etc.). Users 120 may provide their information 220 immediately after registration 210 or any time thereafter, or they may chose not to provide any information, except as required for registration. Information may be subsequently edited (modified, added or deleted) by the user and a user may also deregister from the system 100 at any time for any reason. Further, information requested/required by the system 100 may vary and change from time to time, typically, but not required to be, in response to the criteria which advertisers describe as the target audience for their advertisements.

Subsequent to registration 210 a registered user may login to the System 100 and view advertisements 250. The user 120 may prompt the system to display an advertisement and/or the system may provide the user 120 with options. For example, a user could be provided a single advertisement or a list of advertisements (text list, small or medium icons, or still image from a video advertisement) to select from. The user may also be provided a selection of topics to choose from (e.g. sports equipment, automobiles, home goods, adult, male, female, etc.). The system would then select one or more advertisements targeted to the user's profile that also relates to the selected topic. In this manner the targeting may be refined to the user's current interests. An advertisement may include text, graphics, sound, video, a survey or any combination thereof. It may be a banner advertisement, a still image a video, movie or any other form of advertisement. For ease of explanation, the following description shall be limited to video advertisements. However, those skilled in the art will recognize that the same or a similar description can be applied to the other advertisement formats.

In order to avoid “burn-out” from watching too many advertisements the System 100 may, but is not required to, impose limits on how many advertisements a user can view during a session, how long a given session may last, how many times a user can prompt for a new advertisement during a session, how many times a user can login to the system during a particular time period, etc.

Subsequent to delivering an advertisement, the System 100 may request the user 120 to verify that (s)he viewed the advertisement and that the user's account is not being operated by a machine or computer or program. The verification may be accomplished by any number of conventional methods such as a Completely Automated Public Testing test to tell Computers and Humans Apart (“CAPTCHA”) test and/or requesting the user to answer one or more questions about the advertisement delivered. A user 120 may be required to answer a minimum number of questions correctly as proof that the user was attentive while viewing the advertisement. Once the user has performed the verification, the use may request an additional advertisement in the same manner as described above. It is also contemplated that the user may be provided the option to view another advertisement from the same advertiser, although this feature is not required.

In exchange for registering, providing personal information about themselves and viewing advertisements a user receives tangible compensation. While a preferred form of compensation is online (“virtual”) currency which, optionally, may be converted to actual (“real”) currency, compensation may take different forms and still fall within a scope of the invention. While the following description will focus on virtual currency, compensation may take the form of coupons, actual currency, points, products, or any combination of these.

The payment process 270 includes two main steps. First, upon successful validation the user receives a certain amount of “virtual currency”. The amount of virtual currency that the user receives may depend on several factors including, but not limited to one or more of the following: the amount or detail of personal information the user shared with the System; the frequency with which the user uses the System; the number of advertisements watched by the user; and, scoring results of the user (e.g., proportion of good answers provided during validation process 260). Second, depending on the configuration of the System and the preferences of the user, the virtual currency may be used in a number of different ways, including but not limited to one or more of the following: exchanging virtual currency into real currency (e.g., US dollar) at an exchange rate set by the System's operator; purchasing products and/or services that are offered for sale for virtual currency by the System; participating in various online games or raffles to win cash prizes. These games may be similar to traditional online games or gambling, such as poker, casino, etc. or may be other games specifically developed for the purposes of converting virtual currency to real currency.

During the conversion from virtual currency into real currency the System may, but is not required to, verify that the user's identity was provided to the System correctly. If the user is unable or unwilling to provide proper verification, they system may decline the conversion and/or boot the user from the System and/or cancel the user's account and all compensation allocated to the account.

As a result of the invention, advertisers are able to target and deliver advertisements more effectively. Advertisements are delivered to users who are interested in viewing advertisements and whose' profiles match the target criteria of the advertisement. Advertisers only pay for view verified advertisements. Thus, advertisers do not pay for misdirected advertisements or advertisements that have not been viewed. The System may collect information from users that other techniques do not have access to, and the information received may be more reliable as it is provided directly by the user. As a result of the verification/validation process, the advertiser can be confident that their advertisement was viewed by a target user and that the target use is a real people. It is also likely that the advertisement receives more attention from users. In contrast to typical online advertisements which not only interrupt users in what they are doing but are also typically displayed together with other content and/or advertisements (e.g., several banners appearing simultaneously on a web page), advertisements delivered by the invention are displayed alone without the distraction of any other content. Since the earning of money depends on the user correctly answering questions about the advertisements watched, users are motivated to watch the advertisements attentively. Since the invention is based on the specific and explicit opt-in by users to provide personal information about themselves and all personal information stored by the System is provided by users and not provided to third parties there are no privacy issues as there are with some other advertising methods which may collect information about users without their explicit opt-in and/or without users knowing what information exactly is collected about them. Further, the invention may foster a two-way communication between advertisers and consumers. Since the System provides an interface to users which also accepts inputs (e.g., during validation) the invention offers the possibility of not just simply delivering advertisements to users but also offering an option to users to provide feedback or ask questions from advertisers. Through this interactive communication advertisers can gain continuous, valuable direct feedback from users without the need of conducting a separate expensive market survey.

Users receive compensation for watching advertisements and correctly answering questions about the advertisements watched. They receive a high level of user privacy. All personal information stored by the System is provided by the user who can check this information, and control and modify the depth of this information. Further, personal information is not public and not disclosed or forwarded to any third party. This transparent and controlled use of personal information maximizes privacy for users. Users also get to limit the advertisements that they watch to those that are relevant to them. By providing personal information to the System users are able to influence the advertisements delivered to them and such advertisements should thus be relevant. Accordingly, advertisements provide information on products and services that the user will likely be interested in. Further, users are able to watch advertisements whenever they want and not when the advertisement is forced upon them

Thus it is seen that systems and methods are provided for serving targeted advertisements to users and motivating the users to watch these advertisements. Although particular embodiments have been disclosed herein in detail, this has been done for purposes of illustration only, and is not intended to be limiting with respect to the scope of the claims, which follow. In particular, it is contemplated by the inventor that various substitutions, alterations, and modifications may be made without departing from the spirit and scope of the invention as defined by the claims. For example, the system is described as being set up as a single server that communicates over the Internet. However, the system could also function with multiple servers configured to perform the various operations and/or communications could take place via a network other than the Internet. Additionally, while the system has been described in terms of only receiving information directly from the user it is contemplated that the user could agree to allow the system to follow the user's browsing habits while the user is logged in and thus use this additional information to refine the information provided by the user. It is also contemplated that a user may click on an advertisement or a link associated with an advertisement after beginning to watch the advertisement but prior to completely viewing the advertisement. In such an instance it is contemplated that should the user make a purchase while browsing the advertiser's website that user could be provided with a discount towards the purchase, free shipping and/or some other form of compensation but would not receive additional compensation for viewing the advertisement. However, the advertiser would still be required to pay for that advertisement as if the user fully viewed the advertisement and then verified such viewing. It is also contemplated that the user may be provided the opportunity to purchase the advertised item/service directly from the system. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

It is accordingly intended that all matter contained in the above description or shown in the accompanying drawings be interpreted as illustrative rather than in a limiting sense. It is also to be understood that the following claims are intended to cover all of the generic and specific features of the invention as described herein, and all statements of the scope of the invention which, as a matter of language, might be said to fall there between.

Having described the invention, what is claimed as new and secured by Letters Patent is:

1. A system for selecting and displaying advertisements over a communications network, the system comprising:
a user database configured to store user entered information;
an advertisement database configured to store at least one advertisement;
a target database configured to store target information related to said at least one advertisement;
an advertisement selection application configured to:
receive a request for advertising from a user device, wherein the request is generated by the user device upon a user logging on to the system; and
in response to the request, select at least one advertisement from the advertisement database for display on the user device based at least in part on said user entered information and said target information; and,
a user interface configured to send a verification request to said user device and receive a response indicating that said selected advertisement has been viewed by a user.

2. The system according to claim 1 wherein said response further indicates that said user is a human being.

3. The system according to claim 2 wherein said user interface is further configured to provide a compensation indication for display on said user device in response to receipt of said indication.

4. The system according to claim 1 wherein said advertisement database stores a plurality of advertisements and said selection application is configured to select a plurality of advertisements from said advertisement database and send an indication of said plurality of advertisements for display on said user computer.

5. The system according to claim 1, wherein in response to a user of the user device clicking on the advertisement, a browser of the user computer is directed to a website associated with the advertisement.

6. The system according to claim 1 wherein said advertisement database and said target database are the same database.

7. The system according to claim 1 wherein said upon a user logging on to the system is subsequent to said user logging on to the system.

8. A method for selecting and displaying advertisements over a communications network comprising the steps of:
receiving at a server, from an advertiser, an advertisement and target information related to said advertisement;
storing said advertisement and said target information on said server;
receiving at said server, user information;
storing said user information on said server;
receiving at said server a request for an advertisement;
said server comparing said target information with said user information, determining that a match exists between the target and user information and selecting said advertisement for display on said user device;
said server verifying that said advertisement has been viewed at said user device and compensating a user for viewing said advertisement.

9. The method according to claim 8 further comprising: said server receiving compensation from said advertiser for said verified advertisement.

10. The method according to claim 8 further comprising said server withholding compensation from said user in response to said verifying failing.

11. The method according to claim 8 wherein said target information is selected from the group of criteria comprising end-user location, end-user demographic data, or end-user preferences.

12. The method according to claim 8 wherein in response to a user of the user device clicking on the advertisement, a browser of the user device being directed to a website associated with the advertisement.

13. The method according to claim 12 wherein said advertisement is a video advertisement, and said click occurring prior to a full viewing of said video advertisement, said method further comprising said user receiving a discount towards a purchase on said website associated with said advertisement in lieu of said compensation from said server.

14. The method according to claim 8 further comprising:
receiving and storing at said server a plurality of advertisement and target information related to each of said plurality of advertisements respectively;
said server comparing said target information with said user information, determining that a match exists between a plurality of target information and user information and selecting a plurality of said advertisements for display on said user device;
said server send for display on said user device a list indicating the plurality of matching advertisements;
in response to said list, said sever receiving an advertisement selection and serving said selected advertisement for display on said user device.

15. The method according to claim 8 wherein said compensation is selected from the list consisting of points, actual currency, virtual currency, coupons, products, services, and contest entries.

16. The method according to claim 8 wherein said compensation is converted into currency at a predetermined conversion rate.

17. The method according to claim 8 wherein said server further verifying that said user is a human.

18. The method according to claim 8 further comprising: said server offering a subject of an advertisement for purchase.

19. The method according to claim 8 wherein said advertisement comprises a survey.
